(19) United States
(12) Patent Application Publication
(10) Pub. No.: US 2008/0219419 A1
(43) Pub. Date: Sep. 11, 2008

(54) Method and Device for Forwarding Telephone Data

(75) Inventor: Rainer Wiggers, Greifswald (DE)

Correspondence Address: BELL, BOYD & LLOYD, LLP, P.O. BOX 1135, CHICAGO, IL, 60690, US

(73) Assignee: Nokia Siemens Networks GmbH & Co., KG, Munchen (DE)

(21) Appl. No.: 12/088,222

(22) PCT Filed: Aug. 24, 2006
(86) PCT No.: PCT/EP2006/065649

§ 371 Date: Mar. 26, 2008

(30) Foreign Application Priority Data
Sep. 29, 2005 (DE) 10 2005 046 780.6

(51) Int. Cl. H04M 11/00

(52) U.S. Cl. 379/93.08

(57) ABSTRACT

A device is disclosed in the field of user network access using xDSL processes. ADSL and VDSL processes have long been known. However, the object of the invention is to improve the known devices and processes, in particular the range of the subscriber line, the voltage supply and/or the migration capabilities of switching telephone networks and data transmission networks. This object is achieved by an intermediary unit having the following functionalities: termination of the PoADSL interface, i.e. termination of the ADSL connection (ADSL Interface User Side) at the CO (central office) end, power supply to the intermediary unit (30), provision of a user-oriented ADSL interface (ADSL Interface CO Side), provision of a user-oriented POTS interface (POTS Interface CO Side), an ADSL bridge function between the two ADSL interfaces, and a TDM/IP gateway function between the POTS and ADSL interfaces via the host controller; alternatively, a gateway function is also provided in an IP network.

### CLAIM FOR PRIORITY

This application is a national stage application of PCT/EP2006/065649, filed Aug. 24, 2006, which claims the benefit of priority to German Application No. 10 2005 046 780.6, filed Sep. 29, 2005, the contents of which hereby incorporated by reference.

### TECHNICAL FIELD OF THE INVENTION

The invention relates to a device and to a method for forwarding telephone data to a subscriber line.

### BACKGROUND OF THE INVENTION

Telephone data are, for example, analog telephone data or digital telephone data, particularly ISDN (Integrated Services Digital Network) data. To use the subscriber line at the same time also for a broadband digital data transmission, various proposals have been made, e.g.:
use of ADSL (Asymmetrical Digital Subscriber Line) methods, e.g. according to the ITU-T (International Telecommunication Union—Telecommunication Standardization Sector) Standard G.992.x or ANSI (American National Standards Institute) T1.413, ETSI (European Telecommunications Standards Institute) RTS TM-06006, and
VDSL (Very High Data Rate Digital Subscriber Line) methods, for example according to the ETSI TS 101 270, ITU-T 993.x or ANSI T14.424 Standards.

### SUMMARY OF THE INVENTION

The invention improves upon the range of the subscriber line, with regard to the voltage supply and/or with regard to the migration capability of circuit-switched telephone networks and data transmission networks such as, e.g. the Internet. In addition, in particular, the data transmission rate should also be as high as possible.

In one embodiment of the invention, there is a device including a first connection at the user end which is used for connecting a first line which leads to a terminal of a first user of a data transmission network, a connection at the network end which is used for connecting a line which leads to a node of the data transmission network, a first data separating unit which separates data received at the first connection in a lower frequency band from data received at the first connection in an upper frequency band. Such data separating units are also called splitters. The data received in the lower frequency band are either analog telephone data or digital telephone data, particularly telephone data transmitted according to ISDN. The data received in the upper frequency band are digital data transmitted in data packets, particularly data transmitted in IP (Internet Protocol) data packets.

In another embodiment of the invention, a first telephone data receiving unit which outputs data received in the lower frequency band as digital data, includes a packeting unit which generates payload data packets of a telephone service from the data output by the telephone data receiving unit, a first data packet receiving unit which outputs the data packets received in the upper frequency band, a forwarding unit which forwards the generated payload data packets and the data packets received in the upper frequency band to a transmitting unit at the network end, the transmitting unit sending the generated payload data packets and the received data packets via the connection at the network end.

In one aspect, the data packets have a data packet header in which a destination address and possibly also a sender address are stored. In addition, the data packets have a data packet body which includes the payload data, for example, payload data of a service or signaling data for a service, particularly, for example, voice data, music data, image data, video data, program data, etc.

In particular, the lines are electrically conductive and thus also suitable for a remote voltage supply. In particular, two-wire lines such as twisted two-wire lines, particularly of copper, are suitable.

The device according to one embodiment of the invention enables the number of data separating units or splitters on the subscriber line to be kept low, particularly the number of data separating units or splitters which are passed through by analog telephone data or digital telephone data in a lower frequency band. This is because additional attenuation would be particularly great with respect to these data.

In addition, the device according to another embodiment of the invention allows only one broadband data transmission but not a narrow-band telephone data transmission to be used in the direction of the network operator. A lessee can thus lease only a broadband data transmission line from a network operator and still provide the subscriber with a narrow-band telephone service, for example because this telephone service has a higher voice quality or better availability than an Internet telephone service.

In addition, the device according to still another embodiment of the invention enables a number of narrow-band telephone services of a number of subscribers to be brought together or distributed, respectively. This is attributable to the fact that the lower frequency band on the network side is no longer needed for narrow-band telephone services.

In the device according to yet another embodiment of the invention this device contains a voltage supply unit which generates from a remote power feeding voltage present at the connection at the network end, a local feed voltage for feeding the device. For example, the voltage supply unit contains a DC/DC (Direct Current/Direct Current) converter, particularly a switched-mode power supply. Remote feeding provides for a very cost-effective operation of the device since, for example, no batteries are to be maintained, no power supply connection is required and no solar modules which also includes batteries.

In another embodiment, the voltage supply unit is designed at the network end for feed voltages of greater than 100 volts, particularly greater than 200 volts. The local feed voltage is less than 10 volts, however. Depending on the internal impedance of the voltage source, voltages above 100 volts and particularly above 200 volts can be very dangerous for people and must not pass to a user interface, therefore. For the voltage supply within the data transmission network, however, voltages above 100 volts are particularly suitable for reasons of energy balance. In contrast, the value of the local supply voltage depends on the required voltage of the circuits used. Typical voltages are, for example, 3.3 volts.

In another embodiment, the voltage supply unit generates at the connection at the user end a voltage for feeding an analog telephone connection or a digital telephone connection, preferably a voltage within the range from 30 volts to 99 volts, the upper voltage range being applicable, in particular for ISDN connections. These voltages are harmless to people and can thus be present at a user interface at which users untrained with respect to this interface are also working.

In another embodiment of the device according to the invention, the device includes at least one second connection at the user end, at least one second data separating unit, at least one second telephone data receiving unit, and at least one second data packet receiving unit.

The second elements have with respect to a second line or to a second user, respectively, the same function as the corresponding first elements with respect to the first line and the first user. Thus, the second connection is used for connecting a second line which leads to the second user of the data transmission network.

Due to the second elements, the device can be used for transmitting data from and to a number of subscribers, respectively. In this manner, it is possible to implement the connection of subscribers in rural or thinly-settled regions in a particularly cost-effective manner.

In still another embodiment, the second elements are also fed by the voltage supply unit. The required power of the voltage supply unit increases with the number of further elements. For example, this power reaches a value of more than 4 watts.

In a yet another embodiment, the first data packet receiving unit operates in accordance with an xDSL standard. If necessary, the transmitting unit also operates in accordance with an xDSL standard. For example, the frequency band at the transmitting end is greater than the frequency band at the receiving end because the lower frequency band can also be used for the transmission of data packets in the direction of the network. However, identical frequency bands are also used.

In another embodiment of the invention, there is a method carried out, in particular with the aid of a device according to the invention or one of its developments. The technical effects specified above thus also apply to the method and to its developments, respectively.

### BRIEF DESCRIPTION OF THE DRAWINGS

In the text which follows, exemplary embodiments of the invention will be explained with reference to the attached drawings, in which:

FIG. 1 shows a subscriber line with a remote-supplied intermediary unit.

FIG. 2 shows a block diagram of the intermediary unit

FIG. 3 shows a network topology when using an intermediary unit with distributor function.

### DETAILED DESCRIPTION OF THE INVENTION

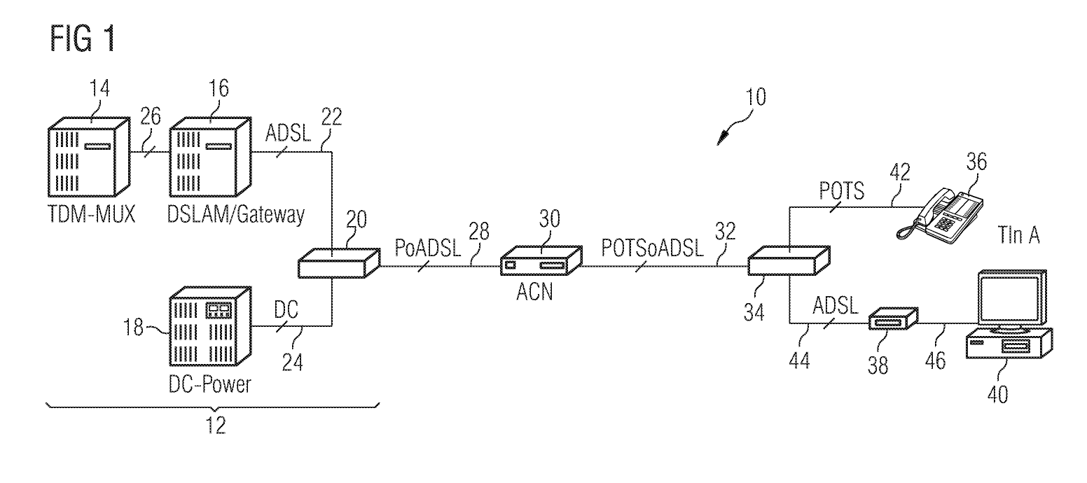

FIG. 1 shows an ADSL line configuration 10. At the end of a network node 12, for example, a central office, the line configuration 10 includes:
an optional timeslot multiplexer 14,
a DSL access multiplexer 16, which is also called DSLAM (Digital Subscriber Line Access Multiplexer),
a remote supply unit 18, and
a separating unit 20.

A line 22 leads from the separating unit 20 to the access multiplexer 16. Transmission on the line 22 occurs in accordance with an ADSL method. A line 24 leads from the separating unit 20 to the remote supply unit 18. On the line 24, a voltage of 200 volts is transmitted, for example. The separating unit 20 is thus used for separating a broadband data transmission signal from a direct voltage or combining the broadband signal and the direct voltage in the opposite direction of transmission.

With its line cards, the access multiplexer 16 terminates the subscriber line or a number of subscriber lines and collects or distributes the DSL data traffic of the end user at the local level and forwards it to a regional DSL-AC (Digital Subscriber Line Access Concentrator), which is then responsible, for example, for the IP routing and, for example, a PPPOE (Point to Point Protocol over Ethernet) termination. If the network node 12 is a central office, an IP telephony link or a number of IP telephony links are optionally terminated or set up, respectively, in the network node 12 by means of a gateway function. The associated voice data are forwarded to the timeslot multiplexer 14 or come from the timeslot multiplexer, see line 26.

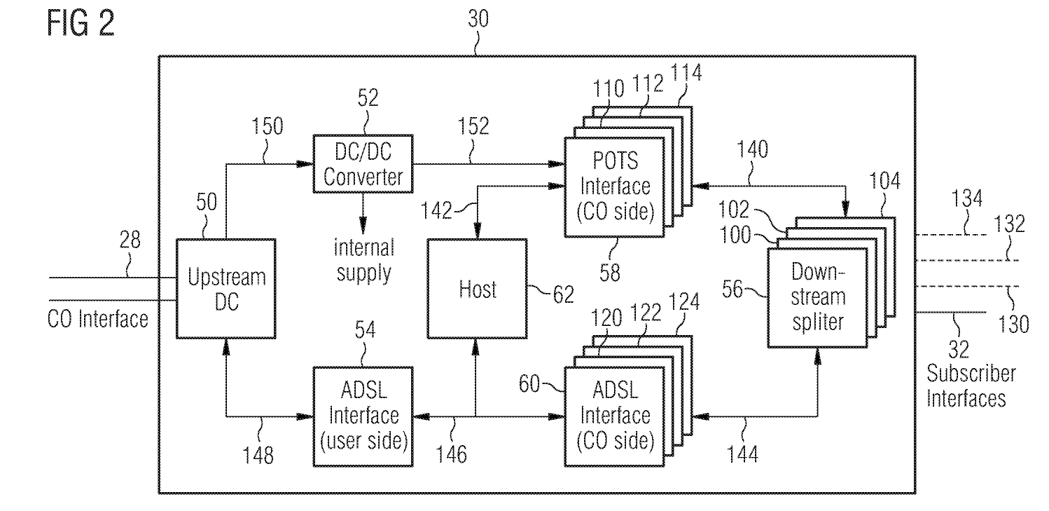

A line 28 leads from the separating unit 20 to an intermediary unit 30, the structure of which will be explained in still greater detail below by means of FIG. 2. Transmission on the line 28 is according to a PoADSL (Power over ADSL) protocol which corresponds essentially to the ADSL standard but wherein a feed voltage of 200 volts is additionally transmitted.

From the intermediary unit 30, a line 32 leads to the subscriber TlnA, more precisely to a separating unit 34 or a so-called splitter. On the line 32, ADSL data are transmitted and in a lower frequency band telephone data are transmitted which is also called POTSoADSL. At the end of the subscriber TlnA, there is also an analog telephone 36, a broadband network termination 38 and a computer or a data processing system 40, respectively.

A line 42 connects the separating unit 34 with the analog telephone 36. On the line 42, analog voice data and signaling signals are transmitted as is normal with conventional analog telephone networks. The designation POTS (Plain Old Telecommunication System) is also used here for such networks.

A line 44 is located between the separating unit 34 and the broadband network termination. Transmission over the line 44 is in accordance with an ADSL method. Between the network termination 38 and the data processing system 40, a line 46 is located via which, for example, data are transmitted in accordance with the Ethernet protocol. The units at the end of the subscriber TlnA operate like units used previously so that reference is made to such units with respect to their function.

The range problem of the broadband application can be solved with the aid of the intermediary unit 30. For this purpose, the intermediary unit 30 is inserted into the subscriber line and here implements a function similar to a traditional repeater or regenerator function. In this application, the following challenges exist, among others:
remote power feeding of the intermediary unit 30 by the network node 12 via the same line 28, by which data are also transmitted,
hybrid implementation of the narrow-band and broadband interface in the direction of user and central office, and
increase of the range of the ADSL interface whilst maintaining a predetermined bandwidth.

In summary, FIG. 1 illustrates the network topology when using the intermediary unit 30 in the application of a hybrid repeater. The special feature of the solution is based, on the one hand, on the principle that the narrow-band service between central office and repeater is implemented via a VOIP protocol (Voice over Internet Protocol), e.g. IETF (Internet Engineering Task Force) SIP (Session Initiation Protocol) or ITU-T H.248. On the other hand, the special feature of the solution consists in an additional remote power feeding source 18 being installed in the central office or in the network node 12, respectively, via which the intermediary unit 30 is fed. The direct current which is normally used for feeding the terminal in the POTS service is thus used in this application for feeding the intermediary unit 30 and the telephone 36 connected to it. Since this interface transmits only the feed voltage apart from the ADSL information, it is called power over ADSL (PoADSL).

When using the intermediary unit 30, the following components are additionally needed:
the intermediary unit 30 itself, which is also called ACN (Active Copper Node),
the remote power feeding unit 18 for remotely feeding the intermediary unit 30, and
optionally a gateway function or gateway assembly within the DSLAM or the access multiplexer 16 for reconverting the VoIP narrow-band connection into the normal TDM (Time Division Multiplexing) method or in the reverse direction, respectively.

FIG. 2 shows a block diagram of the intermediary unit 30. In a first exemplary embodiment, the intermediary unit 30 contains:
a separating unit 50 at the network end,
a voltage supply unit 52,
an ADSL interface 54 at the network end,
a separating unit 56 at the subscriber end, particularly only a single separating unit 56 at the subscriber end, also known as a splitter,
a telephone interface 58,
an ADSL interface 60 at the subscriber end, and
a host computer 62 or a data processing system, respectively.

The ADSL interface 54 and 60 in each case perform, in both directions of transmission, a modulation/demodulation, a coding/decoding and other functions which are required, for example, in an ADSL standard. The separating unit 56 is constructed as active unit or as passive unit. The configuration of the separating unit 56 corresponds to a separating unit hitherto used in a central office or to a known splitter.

The telephone interface 58 includes, in the case of an analog telephone connection 36, an analog/digital converter and a digital/analog converter in order to generate digital data from the analog data. In addition, the interface 58 signals towards the subscriber TlnA in accordance with a protocol for circuit-switched networks.

The separating unit 50 is used for separating broadband digital data and the remote power feeding voltage, or combining broadband data and feed voltage, respectively.

The voltage supply unit 52 contains, for example, a direct-voltage/direct-voltage converter and supplies an internal supply voltage for the intermediary unit 30. In addition, the voltage supply unit 52 generates a voltage for feeding the telephone 36 (see arrow 152).

The host computer 62 performs packetizing of the digital data coming from the telephone interface or, respectively, removes digital voice data from data packets and forwards them to the telephone interface 58, see arrow 142. In addition, the host computer 62 terminates or initiates an Internet telephony link between the intermediary unit 30 and the network node 12, particularly the access multiplexer 16. The host computer 62 also forwards data packets to the ADSL interface 54 and receives data packets relating to the telephone 36 from this interface 54, respectively. In addition, the host computer 62 forwards data packets between the ADSL interfaces 54 and 60, see arrow 146.

An arrow 148 symbolizes the data transmission between the separating unit 50 and the ADSL interface 54 in both directions of transmission. An arrow 150 symbolizes the feed voltage being supplied from the separating unit 50 to the voltage supply unit 52.

An arrow 140 symbolizes the data transmission between the separating unit 56 and the telephone interface 58, i.e. a narrow-band data transmission. In contrast, an arrow 144 symbolizes a broadband data transmission between the separating unit 56 and the ADSL interface 60.

The units represented in FIG. 2 can be implemented with the aid of a processor or also without a processor by means of electronic circuits. On the line 28, a greater frequency band is used, for example, for the broadband data transmission than on the line 32, because no narrow-band telephone data must be transmitted in the lower frequency band on the line 28.

As can be seen from FIGS. 1 and 2, there are only two separating units 56 and 34 relating to the narrow-band telephone data in a lower frequency band between the network node 12 and the devices of the subscriber TlnA. Thus, no additional attenuations are generated in this frequency band by additional separating units.

In another exemplary embodiment, the generating or depacketizing of the data packets for the narrow-band telephone connection is not carried out by the host computer 62 but by the telephone interface 56.

In a second exemplary embodiment, the intermediary unit 30 contains, in addition to the elements already explained:
one or more separating units 100 to 104 at the subscriber end,
one or more telephone interfaces 110 to 114,
one or more ADSL interfaces 120 to 124, and
one or more subscriber lines 130 to 134.

The functions of the separating units 100 to 104 at the subscriber end, of the telephone interfaces 110 to 114, of the ADSL interfaces 120 to 124 and of the subscriber lines 130 to 134 correspond, in this order, to the functions of the separating unit 56 at the subscriber end, of the telephone interface 58, of the ADSL interface 60 and of the subscriber line 32 so that reference is made to the above statements.

In the second exemplary embodiment, signaling occurs on the line 28 in accordance with an ADSL method, e.g. according to ADSL1, ADSL2 or ADSL2+. As an alternative, however, a VDSL method can also be used, e.g. VDSL1 or VDSL2.

The further units 100 to 124, too, are fed by the voltage supply unit 52 and thus via the line 28.

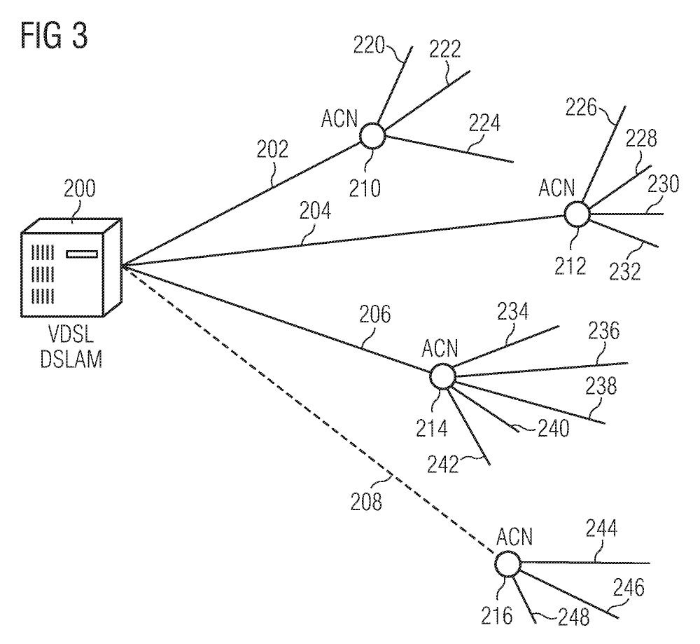

FIG. 3 shows a network topology when using the intermediary unit 30 as distribution unit. In the exemplary embodiment shown in FIG. 3, an access multiplexer 200 is connected via lines 202 to 208 to more than two, for example four, intermediary units 210 to 216, the structure of which corresponds to the structure of the intermediary unit 30 with distribution function. The intermediary unit 210 is connected to more than two, for example, three, subscriber lines 220, 222 and 224. The intermediary unit 212 is also connected to more than two, for example, four subscriber lines 226 to 232. The intermediary unit 214 is connected to five subscriber lines 234 to 242. The intermediary unit 216, finally, is connected to three subscriber lines 244 to 248.

The configuration at the subscriber lines 220 to 248 corresponds to the configuration explained above with reference to FIG. 1 for the subscriber line 32. The telephones 36 used are both analog telephones and ISDN telephones.

The intermediary unit 30 thus provides the following functionalities:
termination of the PoADSL interface, i.e. termination of the CO (Central Office) end of the ADSL connection (ADSL Interface User Side) and power supply for the intermediary unit 30.
provision of an ADSL interface in the user direction (ADSL Interface CO side),
provision of a POTS interface in the user direction (POTS Interface CO side),
ADSL bridge function between the two ADSL interfaces, and
TDM/IP gateway function between POTS and ADSL interface via the host controller, a gateway function in an IP network also being provided as an alternative.

In the second exemplary embodiment, the intermediary unit is used for more than one subscriber interface. This approach becomes significant if the bandwidth provided for the user via the network operator deviates greatly from the technologically feasible data rate of the XDSL technology. For example, ADSL2+ interfaces with data rates of up to 25 Mbit/s (megabits per second) can be implemented, and in turn are exceeded by VDSL solutions. Assuming that a network operator would like to offer a broadband service of e.g. 2 Mbit/s (downstream) to its customers, eight subscribers could also be connected at the same time, e.g. to one intermediary unit 30 without having to deliver bandwidth twice. In this case, the intermediary unit 30 is used in the function of a “distributor node”.

Using this extended intermediary unit 30, a new topology is obtained for an ADSL access network which can also be called a “distributor” DSLAM. It is sufficient for this if only the remote power feeding source and a small concentrator DSLAM with relatively few interfaces are provided centrally. The DSLAM is then connected to remote intermediary unit nodes which then implement the actual ADSL connection to the subscribers. The network structure shown in FIG. 3 is very similar to that of a PON (Passive Optical Network) network—instead of the passive optical fiber distributors, the intermediary unit 30 is based on active electrical copper distributors, however.

As an example, a network of intermediary units with an average distribution factor of 1:4 allows up to 256 subscribers to be connected via a single 64 port DSLAM, to which itself 64 intermediary units 30 are connected, in turn.

Thus, a new active distributor node has been explained which is used in xDSL subscriber line networks and solves the problem of supplying households located remote from the central office with ADSL broadband services, for example, at distances of greater than 2 km, greater than 3 km or greater than 4 km, respectively.

In contrast to the traditional narrow-band services which can be served via relatively long subscriber lines, e.g. 8 km, the range of ADSL services has hitherto been limited to e.g. 4 km (at 2 Mbit/s downstream) in dependence on the required bandwidth. Households connected to the central office via a subscriber line which is longer than the ADSL range could thus hitherto either not be connected or supplied only with significant delays since this is associated with a relatively high expenditure of investment for the network operator.

The solutions given here describe a new network component which is inserted into the subscriber line and, as a result, increases its range. In contrast to traditional regenerator solutions, the special feature of the new use consists in that it offers a solution for implementing, in addition to the ADSL interface, at the same time also the narrow-band interface (POTS or ISDN). Furthermore, the new solution is used as distributor node at which a number of suppliers are connected, which provides for a new tree-like network topology in the ADSL feeder network.

The exemplary embodiments explained use the following technologies and combine them to form a new overall solution:
remote power feeding of remotely operated network components via subscriber lines,
transmission of narrow-band connections via IP networks,
narrow-band interface solutions at the network end, and
ADSL interface solutions at the central office or network and subscriber end.

The special feature consists in that the direct-current path which has previously been used for feeding telephone terminals at ADSL interfaces is used in future for the remote power feeding current of the intermediary unit 30. The narrow-band connection is implemented via a VoIP connection within the subscriber line network, i.e. not recognizably externally.

In particular, the following technical effects are produced:
1. The possibility for connecting far distant subscribers to an ADSL-DSLAM.
2. The possibility of extending a DSLAM multiplexer via remote components and thus improving the scalability of a subscriber line network, particularly at the periphery in rural, thinly-settled, regions.

1. A device for forwarding telephone data, comprising:
a first connection at the user end which is used for connecting a first line which leads to a terminal of a first user of a data transmission network;
a second connection at the network end which is used for connecting a line which leads to a node of the data transmission network;
a first data separating unit which separates data received at the first connection in a lower frequency band from data received at the first connection in an upper frequency band, wherein
the data received in the lower frequency band are either analog telephone data or digital telephone data,
the data received in the upper frequency band are digital data transmitted in data packets;
a first telephone data receiving unit which outputs the data received in the lower frequency band as digital data;
a packeting unit which generates payload data packets of a telephone service from the data output by the telephone data receiving unit;
a first data packet receiving unit which outputs the data packets received in the upper frequency band; and
a forwarding unit which forwards the generated payload data packets and the data packets received in the upper frequency band to a transmitting unit at the network end, the transmitting unit sends the generated payload data packets and the received data packets via the connection at the network end.

2. The device as claimed in claim 1, further comprising a voltage supply unit which generates from a remote power feeding voltage present at the connection at the network end, a local feed voltage for feeding the device.

3. The device as claimed in claim 2, wherein the voltage supply unit is designed at the network end for feed voltages of greater than 100 volts, and/or that the local feed voltage is less than 10 volts.

4. The device as claimed in claim 2, wherein the voltage supply unit generates at the connection at the user end a voltage for feeding an analog telephone connection or a digital telephone connection.

5. The device as claimed in claim 1, further comprising:
at least one second connection at the user end, at least one second data separating unit;
at least one second telephone data receiving unit; and
at least one second data packet receiving unit, wherein the second elements have with respect to a second line and a second user the same function as the corresponding first elements with respect to the first line and the first user.

6. The device as claimed in claim 5, wherein the second telephone data receiving unit and the second data packet receiving unit are fed by voltage supply unit.

7. The device as claimed in claim 1, wherein the first data packet receiving unit operates in accordance with an xDSL method.

8. The device as claimed in claim 1, wherein the transmitting unit operates in accordance with an xDSL method.

9. A method for forwarding telephone data, comprising:
receiving analog telephone data or digital telephone data via a first connection at the user end in a lower frequency band;
receiving data packets via the first connection in an upper frequency band;
generating payload data packets of a telephone service from the telephone data; and
forwarding the generated payload data packets and the received data packets via a connection at the network end.

10. (canceled)

11. The device as claimed in claim 4, wherein the voltage is within the range from 30 volts to 99 volts
